(19) United States
(12) Patent Application Publication
(10) Pub. No.: US 2026/0316472 A1
(43) Pub. Date: Oct. 15, 2026

(54) STENCIL PRINTING OF LIQUID TPU

(71) Applicant: adidas AG, Herzogenaurach (DE)

(72) Inventors: Felix VOELKER, Stegaurach (DE); Patrick MERGENTHALER, Markt Bibart (DE)

(21) Appl. No.: 19/467,483

(22) Filed: Feb. 2, 2026

(30) Foreign Application Priority Data
Feb. 13, 2025 (DE) 10 2025 105 394.4

(51) Int. Cl. B41M 1/12; A43B 13/22; A43D 8/22; B32B 37/00; B32B 38/00; B41M 1/40; B41M 7/00; C08J 7/04; C09D 11/033; C09D 11/38

(52) U.S. Cl. CPC B41M 1/12; A43B 13/223; A43D 8/22; B32B 37/025; B32B 38/145; B41M 1/40; B41M 7/0009; B41M 7/0018; C08J 7/0427; C09D 11/033; C09D 11/38; B32B 2437/02

(57) ABSTRACT

A method for manufacturing an apparel or footwear, such as a shoe (e.g., a sports shoe), comprising: providing a liquified polymer; arranging the liquified polymer onto a support layer via a stencil with one or more cutouts, wherein the liquified polymer is applied through one or more cutouts of the stencil, thereby printing the liquified polymer on the support layer in a pattern; optionally removing the stencil; and curing the printed liquified polymer onto the support layer, thereby obtaining the apparel or footwear or at least a part thereof.

### CROSS-REFERENCE TO RELATED APPLICATION(S)

This application claims priority to German Patent Application No. 102025105394.4, filed Feb. 13, 2025, which is incorporated by reference herein in its entirety.

### TECHNICAL FIELD

Some embodiments of the present disclosure are directed to a method for manufacturing an apparel or footwear, such as a shoe (e.g., a sports shoe). Some embodiments of the present disclosure are directed to an apparel or footwear manufactured according to some embodiments of the method according to the present disclosure. Some embodiments of the present disclosure are directed to an outsole manufactured according to some embodiments of the method according to the present disclosure. Some embodiments of the present disclosure are directed to a sports shoe comprising some embodiments of an apparel or footwear or an outsole according to the present disclosure.

### BACKGROUND

Different types of sport may benefit from different types of footwear to promote performance and functionality. Some methods for manufacturing footwear or apparel (e.g., methods for manufacturing shoes, such as sport shoes) may involve a combination of materials and manufacturing techniques to improve durability, performance, comfort, and sustainability of the footwear or apparel.

Injection molding may be used in the manufacture of soles for footwear. Injection molding may be precise and have the ability to combine materials such as ethylene-vinyl acetate (EVA), thermoplastic polyurethane (TPU), and rubber into a single outsole. This may allow for intricate designs and moreover, different hardness levels. However, it may involve high initial setup costs, limited material compatibility, and concerns about the environmental impact of petroleum-based thermoplastics. Direct injection molding or direct attach technology may create a strong bond between the outsole and the upper, eliminating adhesives, but may require expensive machinery and limit intricate outsole designs.

Another approach is compression molding, which may be cost-effective for large-scale production and may produce durable outsoles. However, compression molding has the disadvantage that it may lack the design flexibility of injection molding. Moreover, this method may further generate waste material during the process which may not be ecologically beneficial.

Vulcanization may also be used to produce durable and resilient rubber outsoles, such as outsoles for high-performance sports shoes, but may be energy-intensive, environmentally taxing due to chemical use, and less suited for flexible, complex patterns. Laser cutting and engraving may enable precision in outsole design, adding functional textures or aesthetic details, but may be restricted to certain materials and may leave surface imperfections, which requires additional finishing.

A common disadvantage of these soles is that the process of sole manufacturing generally cannot be flexibly changed or implemented during the overall manufacture process and its application may be rather rigid. Furthermore, another disadvantage is the generally inflexible design of the sole material, which once prepared cannot be easily changed or adapted to specific needs of the sole.

Furthermore, another disadvantage of conventional solutions may be the use of hazardous and harmful liquids in the manufacture of footwear, such as lightweight footwear. Typically, vaporous solvents which can be removed quickly are used during the process of the manufacture of lightweight sportswear or footwear. However, the usage of these hazardous solvents may require professional handling and specific transportation. Furthermore, this usage may result in the production of chemical waste which may be undesirable during the overall process, as removal and transportation of chemical waste may be costly and complex, and further unbeneficial in terms of environmental aspects.

### BRIEF SUMMARY

Therefore, some embodiments of the present disclosure provide an improved method and outsole, as well as a shoe (e.g., a sports shoe) comprising the apparel or footwear in order to at least partly overcome the above-mentioned deficiencies.

A first embodiment (1) of the present disclosure is directed to a method for manufacturing an apparel or footwear, such as a shoe (e.g., a sports shoe), comprising the steps of: (a) providing a liquified polymer; (b) arranging the liquified polymer onto a support layer via a stencil with one or more cutouts, wherein the liquified polymer is applied through one or more cutouts of the stencil, thereby printing the liquified polymer on the support layer in a pattern; (c) optionally removing the stencil; and curing the printed liquified polymer onto the support layer, thereby obtaining the apparel or footwear or at least a part thereof.

In a second embodiment (2), the liquified polymer according to the first embodiment (1) comprises a polymer and a solvent.

In a third embodiment (3), the solvent according to any one of embodiments (1)-(2) is a water-soluble solvent selected from the group comprising: ethanol, acetone, isopropyl alcohol, methanol, glycerol, propylene glycol and/or dimethyl sulfoxide (DMSO).

In a fourth embodiment (4), the method according to the third embodiment (3), wherein when a water-soluble solvent is used, the step of curing the printed liquified polymer comprises the step of treating the printed liquified polymer with an extraction agent, such as water.

In a fifth embodiment (5), the method according to the first embodiment (1) further comprising the steps of: (e) removing the cured printed polymer from the support layer, thereby obtaining at least a part of the apparel or footwear; and (f) attaching the part of the apparel or footwear to a base layer.

In a sixth embodiment (6), the method according to the first embodiment (1) further comprising the steps of: (g) attaching the support layer with the cured printed polymer to a base layer, in particular a bottom part of a mid-sole; and (h) removing the support layer from the part of the apparel or footwear, thereby obtaining at least a part of the apparel or footwear attached on the base layer.

In a seventh embodiment (7), the attaching according to any one of embodiments (5)-(6) is performed at a temperature between 30 to 300° C., between 50 to 280° C., or between 70 to 260 °C, and/or the attaching is performed in at most 12 min, at most 10 min, at most 6 min, at most 4 min, at most 2 min, or at most 1 min.

In an eighth embodiment (8), the method according to the seventh embodiment (7), wherein in the step of attaching the part of the apparel or footwear to the base layer comprises one or more of glueing, cementing, press-heating, pressing and/or injection molding.

In a ninth embodiment (9), the method according to the eighth embodiment (8), wherein alternatively the step of attaching (165) the part of the apparel or footwear (240) comprises the steps of: (i) melting the part; (j) sintering the melted part; (k) redissolving the sintered part; (l) welding the redissolved part; and (m) pressing the welded part to the base layer.

In a tenth embodiment (10), welding the part according to the ninth embodiment (9) is performed using infrared radiation (IR), high frequency (HF) radiation, and/or ultrasonic radiation.

In a eleventh embodiment (11), arranging the liquified polymer according to any one of embodiments (1)-(10) is performed comprising one or more of: dispensing, spraying, jetting, printing, coating, spin coating, casting, depositing, dipping, brushing, roller coating, injecting and/or additive manufacturing such as stereolithography (SLA) and/or selective laser sintering (SLS).

In a twelfth embodiment (12), the part of the footwear according to any one of embodiments (1)-(11) is an outsole of the shoe (e.g., the sports shoe).

In a thirteenth embodiment (13), the support layer according to any one of embodiments (1)-(12) is a midsole and/or a shoe upper and/or parts thereof.

In a fourteenth embodiment (14), the support layer according to any one of embodiments (1)-(13) is a film.

In a fifteenth embodiment (15), the midsole according to the thirteenth embodiment (13) comprises a polymer selected from the group comprising: thermoplastic polyurethanes (TPUs), polyether block amide (PEBA), ethylene vinyl acetate (EVA), thermoplastic elastomers, polyurethane, and/or expanded thermoplastic polyurethane (eTPU).

In a sixteenth embodiment (16), the liquified polymer according to any one of embodiments (1)-(15) is arranged onto one or more sections of the sports shoe, including a toe section, a forefoot section, a heel section, a midsole section, a sidewall section and/or an upper section.

In a seventeenth embodiment (17), the liquified polymer according to any one of embodiments (1)-(16) is arranged onto one or more predetermined portions of the apparel or footwear determined using a torsion map, an abrasion map and/or a pressure map.

In an eighteenth embodiment (18), the liquified polymer according to any one of embodiments (1)-(17) is arranged onto the support layer with a thickness of 0.1-10 mm, 0.12-4 mm, 0.15-2 mm, 0.17-1 mm, or 0.2-0.8 mm.

In a nineteenth embodiment (19), the thickness of the apparel or footwear or at least a part thereof according to any one of embodiments (1)-(18) is 0.3-0.7 mm, or is 0.5 mm.

In a twentieth embodiment (20), the stencil according to any one of embodiments (1)-(20) is a screen, such as a mesh.

In a twenty-first embodiment (21), the liquified polymer according to any one of embodiments (1)-(20) is arranged in a first section of the apparel or footwear with a dynamic viscosity of 50000 to 200000 mPa·s; and in a second section of the apparel or footwear with a dynamic viscosity of 10000 to 50000 mPa·s.

In a twenty-second embodiment (22), the contact angle between the liquified polymer and the support layer according to any one of embodiments (1)-(21) is 30° to 110°, 40° to 90°, or 50° to 70°.

In a twenty-third embodiment (23), the curing step according to any one of embodiments (1)-(22) is carried out using radiation.

In a twenty-fourth embodiment (24), the liquified polymer according to any one of embodiments (1)-(23) comprises a polymer and a solvent, wherein the polymer is selected from the group of polyurethanes (PU), thermoplastic polyamides (TPE-A or TPA), thermoplastic polyesters (TPE-E or TPE), thermoplastic styrenic block copolymers (TPE-S or TPS), thermoplastic polyurethanes (TPE-U or TPU), thermoplastic vulcanizates (TPE-V or TPV), rubber or ethylene-vinyl copolymer (EVA), and/or combinations thereof.

In a twenty-fifth embodiment (25), the liquified polymer and the support layer, such as a midsole, according to any one of embodiments (1)-(24) are dissolvable by the solvent, wherein optionally the solvent is the same.

In a twenty-sixth embodiment (26), the polymer of the support layer, such as a midsole, according to any one of embodiments (1)-(25), and the liquified polymer are TPU.

In a twenty-seventh embodiment (27), the pattern according to any one of embodiments (1)-(26) is a grid, lattice, line, spiral, honeycomb, dots, wave, sine wave pattern or any combinations thereof.

In a twenty-eighth embodiment (28), the solvent according to any one of embodiments (2)-(27) is a mixture selected from the group of solvent-borne and/or water-borne solvents, such as the group of (C1-C6) ethers, (C1-C10) esters, (C1-C8) ketones, (C1-C8) alkanes, and/or combinations thereof.

In a twenty-ninth embodiment (29), the solvent according to any one of embodiments (2)-(28) is a mixture of one or more of tetrahydrofuran (THF), methyl ethyl ketone (MEK), cyclohexane (CYC), ethyl acetate, butyl acetate, acetone, acetonitrile, benzyl alcohol, chlorobenzene, dichloromethane, dimethyl sulfoxide (DMSO), methyl tert-butyl ether (MTBE), N-methyl-2-pyrrolidone (NMP), dimethylacetamide (DMAC), dimethylformamide (DMF), pyridine, and/or toluene.

In a thirtieth embodiment (30), the ratio of the mixture according to any one of embodiments (28)-(29) is in the range of 10 to 90 vol. %., 20 to 80 vol. %, or 30 to 70 vol. %.

In a thirty-first embodiment (31), the polymer according to any one of embodiments (2)-(30) is characterized by a Shore A value and/or Shore D value, wherein the Shore A value is in the range of 20 to 120, 40 to 100, or 60 to 80; and the Shore D value is in the range of 2 to 80, 5 to 75, or 8 to 70.

In a thirty-second embodiment (32), the concentration of the polymer according to any one of embodiments (2)-(31) is in the range of 5 to 60 wt. %, 7 to 50 wt. %, 10 to 40 wt. %, or 15 to 30 wt. %

In a thirty-third embodiment (33), the liquified polymer according to any one of embodiments (1)-(32) comprises a dynamic viscosity of 10000 to 50000 mPa·s, or of 20000 to 40000 mPa·s.

In a thirty-fourth embodiment (34), in the curing step according to any one of embodiments (1)-(33) a curing temperature of between 20° C. to 250° C., 30° C. to 150° C., or 40° C. to 50° C. is used; and wherein in the step of curing the liquified polymer the curing time is between 2 min to 750 min, 5 min to 390 min, or 10 min to 180 min.

In a thirty-fifth embodiment (35), the curing step according to any one of embodiments (2)-(4), and any or all of embodiments depending therefrom, a curing temperature of between 20° C. to 150° C., 40° C. to 100° C., 60° C. to 80° C., or 72° C. to 78° C. is used; and wherein in the step of curing the liquified polymer the curing time is between 2 min to 24 hours, 5 min to 12 hours, 10 min to 6 hours, or 20 min to 3 hours.

A thirty-sixth embodiment (36) of the present disclosure is directed to an apparel or footwear or at least a part thereof manufactured according to the method according to any one of embodiments (1)-(35).

A thirty-seventh embodiment (37) of the present disclosure is directed to an outsole manufactured according to the method according to any one of embodiments (1)-(35).

In a thirty-eighth embodiment (38), the outsole according to the thirty-seventh embodiment (37) has a surface formed by the cured polymer.

A thirty-ninth embodiment of the present disclosure is directed to a shoe (e.g., a sports shoe) comprising the apparel or footwear or at least a part thereof according to the thirty-sixth embodiment (36) or the outsole according to any one of embodiments (37)-(38).

### BRIEF DESCRIPTION OF THE FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 shows a flow diagram of a method for manufacturing an apparel or footwear according to some embodiments of the present disclosure.

FIGS. 2 to 4 show embodiments of the apparel or footwear manufactured using some embodiments of the method according to the present disclosure.

### DETAILED DESCRIPTION

Some embodiments of the present disclosure are described below, such as embodiments directed to shoes (e.g., sport shoes). It is, however, emphasized that some embodiments of the present disclosure may also be practiced, e.g., in different kinds of soles and shoes and are not limited to the embodiments described herein.

Reference is further made to the fact that some embodiments may be described in more detail than other embodiments. A skilled artisan will understand that the features and possible modifications described with reference to these embodiments may also be further modified and/or combined with one another in a different manner or in different sub-combinations, without departing from the scope of the present disclosure. Individual features or sub-features may also be omitted if they are dispensable. In order to avoid redundancies, reference is therefore made to the explanations in the preceding discussion/sections, which also apply to the following description.

Where a range of numerical values comprising upper and lower values is recited herein, unless otherwise stated in specific circumstances, the range is intended to include the endpoints thereof, and all integers and fractions within the range. It is not intended that the disclosure or claims be limited to the specific values recited when defining a range. Further, when an amount, concentration, or other value or parameter is given as a range, one or more ranges, or as list of upper values and lower values, this is to be understood as specifically disclosing all ranges formed from any pair of any upper range limit or value and any lower range limit or value, regardless of whether such pairs are separately disclosed.

Some embodiments of the present disclosure are directed to a method for manufacturing an apparel or footwear, such as a shoe (e.g., a sports shoe), comprising the steps of:
a. providing a liquified polymer;
b. arranging the liquified polymer onto a support layer via a stencil and/or a screen with one or more cutouts, wherein the liquified polymer is applied through one or more cutouts of the stencil, thereby printing the liquified polymer on the support layer in a pattern;
c. optionally removing the stencil; and
d. curing the printed liquified polymer onto the support layer, thereby obtaining (150) the apparel or footwear or at least a part thereof.

Some embodiments of the method according to the present disclosure may provide a beneficial and flexible process for manufacturing an apparel or footwear. A conventional sole structure, for example an outsole for a sports shoe, usually is manufactured by, e.g., injection molding. Some embodiments of the method according to the present disclosure are based on a different approach, for example, the production of a liquified polymer by, e.g., mixing the polymer and the solvent and/or additives which is then printed via a stencil on a support layer. Some embodiments of the method according to the present disclosure may be more efficient as compared to conventional methods, as these embodiments may integrate the steps of arranging and printing the liquified polymer onto a support layer into the production process. Furthermore, application of the liquified polymer via a stencil may offer flexibility for customization of the apparel or footwear and the overall process. This dual capability may be valuable for improving the apparel or footwear and its method for manufacturing. Additives may impact stability, viscosity, curability and/or solubility.

Some embodiments of the method according to the present disclosure may be used for the manufacture of accessories and/or garments. For example, in some embodiments, the method may be used for the back of a football glove or the upper of a football boot. In this regard, in some embodiments, silicone may be used in the method and, e.g. stencil printed.

Some embodiments of the method according to the present disclosure may eliminate the need for additional process steps for producing a pattern, which may reduce cycle time and increase throughput. Furthermore, in some embodiments, the combination of arranging, applying and printing the liquified polymer in a single step may avoid the cost of post-processing equipment like lasers or chemical etching systems and may reduce labor costs. For example, in some embodiments, when printing on a structured support layer, the structure may be transferred on the apparel and/or footwear as well. The obtained pattern by the application of the liquified polymer via stencil and curing may result in overall fewer processing steps, which may lead to lower energy consumption of the overall process, such as for heating, handling, or operating additional machinery. Some embodiments of the method according to the present disclosure may further allow for individual changes or customization during the process, like unique branding, part identification, or product differentiation by adapting the stencil without the necessity to alter the process. In this manner, in some embodiments, process cost and time of creating new molds or dies when a different pattern and/or surface structure is required is avoided, leading to a more cost-efficient process.

Furthermore, when using some embodiments of the method according to the present disclosure, a scalable process may be provided. E.g., when increasing the production volume, some embodiments of the method according to the present disclosure remains efficient. For example, attaching the part and/or the apparel or footwear may take place during the step of curing, which may be incorporated as an automated process, and may lead to high repeatability and high throughput.

Moreover, when using some embodiments of the method according to the present disclosure, e.g., glue-and injection molding-based deposition may be avoided while providing an apparel or footwear in a cost-and time-efficient manner, as less material may be required. Moreover, some embodiments of the present disclosure provide for a support layer which may be advantageous in terms of transportation and flexibility for subsequent steps, such as a direct attachment process.

Accordingly, some embodiments of the method according to the present disclosure may improve speed, cost, flexibility in automation (e.g., an automated, scalable approach), material efficiency, risk management (e.g., reduced handling of hazardous material) and customization of the overall process for manufacturing an apparel or footwear.

While some embodiments of the apparel or footwear may be used to create a lighter and thinner, e.g., outsole, the apparel or footwear may be further used to enhance the design and visual appeal of the shoe (e.g., the sports shoe), e.g., when arranging the liquified polymer in particular zones of the footwear and/or sportswear. For example, a finer and delicate apparel and/or footwear may obtained by some embodiments of the method according to the present disclosure, which may not be achieved with conventional processes, such as molding.

In this manner, in some embodiments, the apparel or footwear may be manufactured more efficiently while the liquified polymer can be arranged more precisely and effectively. By doing so, in some embodiments, no material waste may be produced, e.g., by cutting excess material. In this manner, some embodiments of the method according to present disclosure may provide for an improved method for producing the sole structure for, e.g., a sports shoe, by only consuming as much material as needed and avoiding any waste production.

Some embodiments of the method according to the present disclosure have shown to provide an apparel or footwear which may enhance the performance of an athlete while reducing the overall weight of the apparel or footwear. When using the apparel or footwear according to some embodiments of the present disclosure, the running performance of the wearer, e.g., an athlete, may be improved due to its lightweight characteristic. Due to the reduced weight, in some embodiments, the apparel or footwear may provide for an improved overall workout experience and result. For example, and when comparing to conventional apparel or footwear, the apparel or footwear of the present disclosure may exhibit an improvement in weight. Moreover, in some embodiments, the apparel or footwear has the advantage that it can be individually designed based on the needs and requirements of the, e.g., athlete. Furthermore, in some embodiments, the apparel or footwear may be considerably thinner, due to the materials and manufacturing process, making the overall apparel or footwear more desirable and visually appealing.

As used herein, an “apparel” according to present disclosure is, but not limited to, any part of clothing or garments designed for wear. Apparel encompasses a wide range of items, including outerwear, underwear, footwear, and accessories, made for different purposes such as fashion, functionality, or cultural expression. Apparel comprises any part of a sportswear.

As used herein, a “footwear” according to present disclosure is, but not limited to, any garments worn on the feet for protection, comfort, and/or style. Footwear comprises a wide variety of items such as shoes, sandals, boots, slippers, particularly athletic and/or sport shoes. Footwear provides for support, cushioning, and/or traction. Footwear comprises also any part of a shoe or footwear or sportswear that provides structure, texture and/or traction for the wearer.

As used herein, a “polymer” according to present disclosure is, but not limited to, a polymer material. In some embodiments, the polymer material may be made from durable and long-lasting materials. In some embodiments, the polymer material may provide for the contacting zone, which is in contact with, e.g., the ground during, for example, the course of a gait. Furthermore, the polymer material may provide for flexibility, durability, cushioning, and support in the apparel or footwear.

As used herein, a “support layer” according to present disclosure is, but not limited to, a structural or functional component in a system, designed to provide stability, protection, or additional functionality to, e.g., the polymer. In some embodiments, the support layer may be a thin film such as a film layer, that is used for arranging the polymer on said support layer. The liquified polymer may be flexibly and easily further processed, e.g., in an attachment process, such as heat-pressing the arranged polymer via the support layer onto a further component (e.g. mid-sole and/or outsole) or transported, stored and subjected on the support layer to another process step. A support layer may help to maintain the structural integrity of the apparel or footwear or part thereof. The support layer does not necessarily need to be part of the sports shoe, for example, and may be removed when further processing the apparel or footwear. The support layer may be, e.g., a midsole and include materials that absorb shock and reduce the impact on the joints. The support layer may be made from durable materials to withstand the wear and tear of regular use. The support layer may work in conjunction with other layers of the apparel or footwear and the shoe (e.g., the sports shoe). For example, in some embodiments, a support layer may comprise textile, fiber, polyester-based materials, nylon or the like.

As used herein, the “liquified polymer” is, but not limited to, a polymer having semi-solid or liquid physical properties. In some embodiments, the liquified polymer may comprise a polymer and a liquifying element, such as a solvent.

As used herein, “curing” according to present disclosure is, but not limited to, a chemical and/or physical process of hardening, setting and/or solidification of the polymer. In some embodiments, curing may be carried out using radiation.

As used herein, “mixing” according to present disclosure is, but not limited to, a process of combining one or more substances resulting in a mixture of the individual substances. In some embodiments, the mixture is in a liquid form.

As used herein, “arranging” according to present disclosure is, but not limited to, a process of applying and/or depositing, for example, the liquified polymer onto the support layer.

As used herein, “printing” according to present disclosure is, but not limited to, any process used to apply, e.g., designs, patterns, branding, or functional elements to shoe components. In some embodiments, the components may be components of an apparel or footwear, such as uppers, soles, or insoles. In some embodiments, printing may serve aesthetic, functional, and/or branding purposes.

In some embodiments of the present disclosure, the apparel or footwear may be an outsole of the shoe (e.g., the sports shoe). In some embodiments, the liquified polymer may comprise a polymer and a solvent. The polymer, in some embodiments, may be a mixture of one or more polymers. In some embodiments, the mixture may comprise pigments, coloring and/or additives. In some embodiments, the solvent may be a water-soluble solvent selected from the group consisting of: ethanol, acetone, isopropyl alcohol, methanol, glycerol, propylene glycol, and dimethyl sulfoxide (DMSO).

These solvents may emit fewer volatile organic compounds (VOCs) compared to traditional organic solvents, which may make them eco-friendlier and more compliant with environmental regulations. Furthermore, in some embodiments, the solvent may degrade more easily in the environment, which may reduce long-term environmental impact. Moreover, these solvents may be less toxic and hazardous compared to conventional solvents, which may reduce health risks, such as respiratory issues or skin irritation, when handling the solvents. In some embodiments, the solvent(s) are non-flammable, which may enhance workplace safety by minimizing fire hazards.

Cost-effectiveness is another advantage of some embodiments of the present disclosure, as the solvents of the present disclosure may involve lower disposal costs due to simpler waste treatment and may be economically diluted with water, reducing reliance on expensive chemicals. Process efficiency may also be enhanced as some embodiments of the solvents according to the present disclosure may simplify equipment cleaning—and may require just water for residue removal—and may allow for flexible formulation adjustments by easy mixing and dilution. Additionally, in some embodiments, these solvents may contribute to better product quality, such as smoother and more uniform coatings or adhesives. Accordingly, in some embodiments, these benefits may be further enhanced by, e.g., water-base solvents.

When a water-soluble solvent is used, according to some embodiments of the present disclosure, the step of curing the printed liquified polymer may comprise the step of treating the printed liquified polymer with an extraction agent, such as water.

For example, in some embodiments, for extracting the solvent, e.g., DMSO, from the printed liquified polymer, which may be located onto a support layer, the extraction agent, e.g., water, may be applied for example by spraying the extraction agent onto the printed liquified polymer. In this manner, in some embodiments, the extraction agent may be applied onto the printed, still liquid polymer. In this manner, in some embodiments, the extraction agent may extract the solvent of the liquified polymer and may solidify the printed polymer on the support layer. Another approach according to the present disclosure may comprise, e.g., dipping the printed liquified polymer into a bath comprising the extraction agent, e.g., water. In some embodiments, the printed liquified polymer may remain in contact with the water for several minutes. In this manner, in some embodiments, the solvent in the liquified polymer may be removed by extracting the solvent by the extraction agent present in the bath. In some embodiments, the longer the contact time, the more solvent may be removed.

In some embodiments, after extracting the solvent from the printed liquified the solvent/extraction-agent may be removed from the printed liquified polymer by, e.g., wiping. In some embodiments, the extraction agent may, e.g., evaporate quicker than the solvent during the step of curing. In this manner, in some embodiments, the solvent would remain on the surface of the printed liquified polymer. This remaining solvent may then liquefy the printed polymer. In some embodiments, the step of extraction may be performed more than once. In this manner, in some embodiments, such configurations may promote the solvent being sufficiently removed.

In some embodiments, the step of dipping (e.g., into a water bath) may be performed for at least 1 hour. In some embodiments, the step of dipping (e.g., into a water bath) may be performed for 2 hours. In some embodiments, the step of dipping (e.g., into a water bath) may be performed for 4 hours. In some embodiments, the step of dipping (e.g., into a water bath) may be performed for 8 hours. In some embodiments, the step of dipping (e.g., into a water bath) may be performed for 12 hours. In some embodiments, the step of dipping may be performed for 10 days. In some embodiments, the step of dipping may be performed for 7 days.

Some embodiments of the method according to the present disclosure may further comprise the steps of:
e. removing the cured printed polymer from the support layer, thereby obtaining at least a part of the apparel or footwear; and
f. attaching the part of the apparel or footwear to a base layer.

Some embodiments of the method according to the present disclosure may further comprise the steps of:
g. attaching the support layer with the cured printed polymer to a base layer, in particular a bottom part of a mid-sole; and
h. removing the support layer from the part of the apparel or footwear, thereby obtaining at least a part of the apparel or footwear attached on the base layer.

Some embodiments of the method according to the present disclosure avoid, e.g., glue-and injection molding-based deposition and may provide an apparel or footwear in a cost-and time-efficient manner, as less material may be required. Furthermore, some embodiments of the method according to the present disclosure may use a support layer, which may be advantageous in terms of transportation and flexibility during the process and subsequent steps, such as a direct attachment process.

In some embodiments, attaching may comprise bringing into contact the part of the apparel or footwear/base layer to be attached on (or both) into contact with the solvent, e.g., DMSO. In this manner, in some embodiments, the solvent may redissolve the contacted material.

In some embodiments, the solvent may be used in an amount of at least 0.0001 ml/cm². According to some embodiments, the solvent may be used in an amount of at least 0.001 ml/cm². According to some embodiments, the solvent may be used in an amount of at least 0.01 ml/cm². According to some embodiments, the solvent may be used in an amount of at least 0.1 ml/cm². According to some embodiments, the solvent may be used in an amount of at least 1 ml/cm².

In this regard, in some embodiments, the solvent may be applied by various means such as brushing, spraying and/or dipping. In some embodiments, the volume of solvent may depend on the kind of polymer used.

According to some embodiments, attaching may be performed at a temperature ranging from 30° C. to 300° C.. According to some embodiments, attaching may be performed at a temperature ranging from 50° C. to 280° C. According to some embodiments, attaching may be performed at a temperature ranging from 70° C. to 260° C.

In some embodiments, when heat-pressing the part of the apparel, the temperature may be adjusted to be sufficient to at least soften the component and the, e.g., midsole material. In some embodiments, the temperature may vary from the temperature ranges described herein.

In addition, or alternatively, in some embodiments, attaching may be performed in at most 12 minutes. In some embodiments, attaching may be performed in at most 10 minutes. In some embodiments, the attaching may be performed in at most 6 minutes. In some embodiments, attaching may be performed in at most 4 minutes. In some embodiments, attaching may be performed in at most 2 minutes. In some embodiments, attaching may be performed in at most 1 minute.

In some embodiments, the step of attaching the part of the apparel or footwear to the base layer may comprise one or more of glueing, cementing, press-heating, pressing and/or injection molding.

In addition, or alternatively, in some embodiments, the step of attaching the part of the apparel or footwear may comprise the steps of:
i. melting the part,
j. sintering the melted part,
k. redissolving the sintered part,
l. welding the redissolved part; and
m. pressing the welded part to the base layer.

In this regard, in some embodiments, the base layer may be a mid-sole. For example, in some embodiments, the support layer of the part of the apparel or footwear may be removed. In some embodiments, the support layer of the part of the apparel or footwear may be remained and removed at a later step. In some embodiments, when using DMSO to redissolve the part and/or the base layer, e.g., the midsole, each or both components may be brought into contact with the solvent, e.g., DMSO. Afterwards, the part of the apparel comprising the stencil-printed pattern, which may be arranged on the support layer, for example a film layer, is placed on the midsole. In such configurations (as well as others), the film layer may be removed after placing the part on the mid-sole.

In some embodiments, the midsole may be placed on a support structure, e.g., to prevent deformation when under pressure. For example, in some embodiments, a component comprising a negative of the pattern of the midsole/outsole surface structure may be placed on the support layer, e.g., the film layer. Subsequently, in some embodiments, the part which is placed on the base layer may be subjected to the step of drying. During the step of drying, in some embodiments, weights are applied. In some embodiments, the method may further comprise the step of drying the base layer together with the welded part.

In some embodiments, in the step of drying, a weight of at least 100 g is applied. In some embodiments, in the step of drying, a weight of at least 1 kg is applied. In some embodiments, in the step of drying, a weight of at least 10 kg is applied. In some embodiments, in the step of drying, a weight of at least 100 kg is applied.

In this manner, in some embodiments, the weight promotes all parts of the part of the apparel being in contact with the base layer, e.g., the midsole, surface to ensure sufficient and complete bonding.

In some embodiments, when heat-pressing the part to the base layer, and when using DMSO to redissolve the part and/or the base layer, e.g., the midsole, each or both may be brought into contact with the solvent, e.g., DMSO. Subsequently, in some embodiments, the part of the apparel comprising the stencil-printed pattern, which may be arranged on a support layer, e.g. a film, may be placed on the midsole.

In some embodiments, the midsole may be placed on a support structure, e.g., to prevent deformation when under pressure. After that, in some embodiments, a top piece showing a negative of the pattern of the midsole/outsole structure may be placed on top of the transfer film. Afterwards, in some embodiments, the placed part on the base layer may be subjected to the step of pressing. In some embodiments, the method may further comprise the step of pressing the base layer with the part. In some embodiments, the method may further comprise the step of pressing the base layer with the part by, e.g., using heat. During the step of pressing, in some embodiments, weights are applied.

In some embodiments, in the step of pressing/drying, a weight of at least 10 g is applied. In some embodiments, in the step of drying, a weight of at least 100 g is applied. In some embodiments, in the step of drying, a weight of at least 1 kg is applied. In some embodiments, in the step of drying, a weight of at least 10 kg is applied. In some embodiments, in the step of pressing/drying, a weight of at least 50 kg, 80 kg, and/or 100 kg is applied.

In some embodiments, a combination of attachment process and heat-pressing may be used. For example, attaching/bonding via a solvent, e.g., DMSO, may be applied and subsequently a heat-pressing step may be performed. In this manner, bonding is promoted, in, for example, on the rim of the apparel and/or part and/or base layer.

In some embodiments, welding the part may be performed using infrared radiation (IR), high frequency (HF) radiation, and/or ultrasonic radiation.

In some embodiments, arranging the liquified polymer may be performed comprising one or more of: dispensing, spraying, jetting, printing, coating, spin coating, casting, depositing, dipping, brushing, roller coating, injecting and/or additive manufacturing, such as stereolithography (SLA) and/or selective laser sintering (SLS).

In some embodiments, the liquified polymer may be arranged onto the support layer by 3D printing. In some embodiments, 3D printing comprises additive manufacturing methods, such as stereolithographic methods and laser sintering. With stereolithographic methods light may cause chemical monomers and oligomers to cross-link together to form layer-wise polymers making up the 3D printed object. With laser sintering, a laser may cause powdered material to sinter due to heat. In some embodiments, aiming the laser at points in space defined by a 3D model may bind the material together and create a solid structure. Another example of an additive manufacturing method is fused deposition modeling in which the part may be produced by extruding small beads or streams of material which quickly harden to form layers. If both the midsole and the upper are manufactured using a 3D printing process, the midsole and the upper may be manufactured in separate 3D printing processes and connected afterwards, e.g., by gluing, welding, sewing, etc. In some embodiments, the midsole and the upper may be manufactured together in a single manufacturing step.

In some embodiments, the part of the footwear may be an outsole of the shoe (e.g., the sports shoe). In some embodiments, the support layer may be a midsole and/or a shoe upper and/or parts thereof. In some embodiments, the support layer may be a film.

Accordingly, in some embodiments, the liquified polymer may be arranged onto, e.g., the midsole, and may form an outsole. In some embodiments, the polymer material of the midsole may be an ethylene-vinyl acetate (EVA), a thermoplastic urethane (TPU) or a supercritical foam. These materials may provide good cushioning properties while being relatively lightweight.

In some embodiments, the midsole may comprise a polymer selected from the group consisting of: thermoplastic polyurethanes (TPUs), polyether block amide (PEBA), ethylene vinyl acetate (EVA), and/or thermoplastic elastomers, polyurethane, and/or expanded thermoplastic polyurethane (eTPU).

In some embodiments, the liquified polymer may be arranged onto one or more regions of the shoe (e.g., the sports shoe), including a toe region, a forefoot region, a heel region, a midsole region, a sidewall region, and/or an upper region.

In some embodiments, the liquified polymer may be arranged onto one or more predetermined regions of the apparel or footwear determined using a torsion map, an abrasion map, and/or a pressure map. In some embodiments, the liquified polymer may be applied onto different sections while being individually textured in the subsequent steps. Moreover, in some embodiments, the liquified polymer may be arranged onto a plurality of sections.

In some embodiments, the liquified polymer may be arranged onto one or more predetermined portions of the sports shoe determined using a torsion map, an abrasion map and/or a pressure map. This has the advantage that the apparel or footwear may be individually adapted to specific needs of the user.

In some embodiments, the liquified polymer may be arranged onto the support layer with a thickness ranging from 0.1 mm to 10 mm. In some embodiments, the liquified polymer may be arranged onto the support layer with a thickness ranging from 0.12 mm to 4 mm. In some embodiments, the liquified polymer may be arranged onto the support layer with a thickness ranging from 0.15 mm to 2 mm. In some embodiments, the liquified polymer may be arranged onto the support layer with a thickness ranging from 0.17 mm to 1 mm. In some embodiments, the liquified polymer may be arranged onto the support layer with a thickness ranging from 0.2 mm to 0.8 mm.

In some embodiments, the thickness of the apparel or footwear or at least a part thereof (e.g., the thickness of the polymer and the support layer, together) may range from 0.3 mm to 0.7 mm. In some embodiments, the thickness of the apparel or footwear or at least a part thereof may be 0.5 mm.

In some embodiments, the stencil may be a screen, such as a mesh.

In some embodiments, the liquified polymer may be arranged in a first section of the apparel or footwear with a dynamic viscosity ranging from 50000 mPa·s to 200000 mPa·s; and in a second section of the apparel or footwear with a dynamic viscosity ranging from 10000 mPa·s to 50000 mPa·s.

In some embodiments, the contact angle θ between the liquified polymer and the support layer may range from 30° to 110°, from 40° to 90°, or from 50° to 70°.

In some embodiments, the curing step may be carried out using radiation.

In some embodiments, the liquified polymer may comprise a polymer and a solvent. The polymer may be selected from the group consisting of polyurethanes (PU), thermoplastic polyamides (TPE-A or TPA), thermoplastic polyesters (TPE-E or TPE), thermoplastic styrenic block copolymers (TPE-S or TPS), thermoplastic polyurethanes (TPE-U or TPU), thermoplastic vulcanizates (TPE-V or TPV), rubber or ethylene-vinyl copolymer (EVA), and/or combinations thereof.

These polymers may provide an enhanced applicability. Moreover, in some embodiments, the use of these specific polymers has shown that a time efficient and sustainable process in the production of the apparel or footwear may be achieved while providing for a more durable and long-lasting sole structure. Suitable polymer materials may be elastic foam materials, such as thermoplastic elastomers and/or elastomers.

In some embodiments, the liquified polymer and the support layer which is not a film layer may be dissolvable by the solvent. In some embodiments, a base material of the solvent is the same as a base material of the liquified polymer.

In some embodiments, the polymer of the support layer and the liquified polymer may be TPU.

In some embodiments, the pattern may be a grid, a lattice, a line, a spiral, a honeycomb, dots, a wave, a sine wave pattern or any combinations thereof. In some embodiments, the pattern may be selected from the group comprising one or more of: a rectangle, a grid, a lattice, a line, a spiral, a honeycomb, dots, a wave, or any combination thereof. In some embodiments, the apparel or footwear may be individually designed and may provide a plurality of patterns. In some embodiments, the apparel or footwear may have more than one surface structure. Alternatively, or in addition, in some embodiments, the pattern may be an outlined and/or filled pattern.

These specific patterns may improve the traction of the apparel or footwear, which may help the wearer to maintain a secure footing on a variety of surfaces. Due to this improved traction, the wearer may experience greater stability, which may reduce the chances of slipping or losing balance. This may be important in sports requiring sudden stops, lateral movements, and quick turns, such as, e.g., running, football, basketball, and tennis.

In some embodiments, the solvent may be a mixture selected from the group of solvent-borne and/or water-borne solvents. In some embodiments, the solvent may be a mixture selected the group of (C₁-C₆) ethers, (C₁-C₁₀) esters, (C₁-C₈) ketones, (C₁-C₈) alkanes, and/or combinations thereof.

In some embodiments, the use of these polymers may allow for a time efficient and sustainable process in the production of the component. Suitable polymer materials may be elastic foam materials, such as thermoplastic elastomers and/or elastomers. In some embodiments, the polymer materials may be urethane-based thermoplastic elastomers (TPU), polyester-based thermoplastic elastomers (TPE) and/or polyamide-based thermoplastic elastomers (TPA).

These solvents have shown compatibility with the some embodiments of the method according to the present disclosure, while allowing for flexible adaptation of physical characteristics of the polymer to the requirements of the product and the process.

In some embodiments, the solvent may be a mixture of one or more of tetrahydrofuran (THF), methyl ethyl ketone (MEK), cyclohexane (CYC), ethyl acetate, butyl acetate, acetone, acetonitrile, benzyl alcohol, chlorobenzene, dichloromethane, dimethyl sulfoxide (DMSO), methyl tert-butyl ether (MTBE), N-methyl-2-pyrrolidone (NMP), dimethylacetamide (DMAC), dimethylformamide (DMF), pyridine, and/or toluene. In some embodiments, the solvent may be cyclohexanone.

These solvents may be advantageous, as they may be removed in a time efficient manner during the curing process and may allow for a production process that is capable of adapting to various physical properties of the liquid polymer.

In some embodiments, the ratio of the mixture may range from 10 vol. % to 90 vol. %., from 20 vol. % to 80 vol. %, or from 30 vol. % to 70 vol. %.

In this manner, in some embodiments, these ratios of the mixture of the solvent show best compatibility for both mixing the polymer and changing/adapting the physical characteristics of the liquified polymer to the special requirements of the product and the process.

Accordingly, in some embodiments, these ratios of solvent to the polymer may allow for convenient use in the deposition process and flexible adaptation to the requirements of the product and/or process.

In some embodiments, the polymer may be characterized by a Shore A value and/or Shore D value, wherein the Shore A value may range from 20 to 120, from 40 to 100, or from 60 to 80; and the Shore D value may range from 2 to 80, from 5 to 75, or from 8 to 70.

In some embodiments, the use of a polymer comprising these Shore A and/or Shore D values may provide for the durable properties of the polymer layer and the overall sole structure.

In some embodiments, the concentration of the polymer may range from 5 wt. % to 60 wt. %, from 7 wt. % to 50 wt. %, from 10 wt. % to 40 wt. %, or from 15 wt. % to 30 wt. %.

In some embodiments, the liquified polymer may comprise a dynamic viscosity ranging from 10000 mPa·s to 50000 mPa·s, or from 20000 mPa·s to 40000 mPa·s. In some embodiments, the liquified polymer may comprise a dynamic viscosity ranging from 100000 mPa·s to 500000 mPa·s, or From 100000 mPa·s to 300000 mPa·s.

Different viscosities may be obtained, in some embodiments, by varying the mixing ratio of the solvent and the polymer. In this manner, in some embodiments, it is possible to deposit different viscous materials on the second component by using one operation step. In this manner, some embodiments of the method according to the present disclosure allow for flexible adaptation of the operation step based on the needs of the product.

In some embodiments, in the curing step, a curing temperature ranging from 20° C. to 250° C., from 30° C. to 150° C., from 40° C. to 50° C. may be used; and wherein in the step of curing the liquified polymer the curing time may range from 2 minutes to 750 minutes, from 5 minutes to 390 minutes, or from 10 minutes to 180 minutes.

In some embodiments, in the curing step a curing temperature ranging from 20° C. to 150° C., from 40° C. to 100° C., from 60° C. to 80° C., or from 72° C. to 78° C. may be used; and wherein in the step of curing the liquified polymer the curing time may range from 2 minutes to 24 hours, from 5 minutes to 12 hours, from 10 minutes to 6 hours, or from 20 minutes to 3 hours. In some embodiments, in the step of curing the liquified polymer the curing time may range from 2 minutes to 750 minutes, from 5 minutes to 390 minutes, or from 10 minutes to 180 minutes.

In some embodiments, these curing conditions allow for the cost-and energy-efficient process for the production of the apparel or footwear.

Some embodiments of the present disclosure are directed to an apparel or footwear or at least a part thereof manufactured according to some embodiments of the method according to the present disclosure. The apparel or footwear may have the advantage, in some embodiments, that it can be individually designed based on the needs of the wearer/user, by adapting the stencil shape during the process. Furthermore, in some embodiments, the apparel or footwear may be lighter and thinner, due to the materials and manufacturing process, which may make the overall apparel or footwear or part thereof more desirable.

Some embodiments of the present disclosure are directed to an outsole manufactured according to some embodiments of the method according to the present disclosure. In some embodiments, the outsole may have a surface structure formed by the cured polymer. In some embodiments, the surface structure may be affected by the support layer. For example, in some embodiments, when using, e.g., a support layer having a smooth and even surface, the cured polymer may have a smooth and even surface structure. As another example, when using, e.g., a support layer with an uneven and rough surface, the cured polymer may have an uneven and rough surface structure.

In some embodiments, the outsole may be thinner and lighter than conventional outsoles. Moreover, in some embodiments, the outsole may be individual designed and adapted to specific needs of the user. In some embodiments, the outsole may comprise one or more surface structures. In some embodiments, the outsole may comprise different surface structures, which may provide different functionalities to the outsole. In some embodiments, the outsole comprises a plurality of surface structures, which may be identical in terms of pattern, but differ in depth, thickness or the like.

In some embodiments, the outsole may provide traction and grip when used by a wearer. Furthermore, in some embodiments, the surface structure may allow for a smooth and/or rough design, which may be desirable for the user. While the apparel or footwear may be used to create a lighter and thinner, e.g., outsole, in some embodiments, the apparel or footwear may be additionally or alternatively used to enhance the grip of the shoe (e.g., the sports shoe) for particular workouts, e.g., when arranging the liquified polymer in particular zones of the sports shoe.

Some embodiments of the present disclosure are directed to a sports shoe comprising an apparel or footwear or at least a part thereof according to some embodiments of the present disclosure and/or an outsole according to some embodiments of the present disclosure.

In some embodiments, the shoe (e.g., the sports shoe) comprising the outsole according to some embodiments of the present disclosure may be considerably lighter, and thinner, and may make the overall shoe (e.g., the sports shoe) more desirable. In some embodiments, the shoe (e.g., the sports shoe) may exhibit enhanced durability and performance properties compared to conventional shoes due to the use of the outsole according to some embodiments of the present disclosure.

The many advantages discussed in the context of some embodiments of the present disclosure may apply also to other embodiments of the present disclosure. For example, the advantages discussed for some embodiments of the method according to the present disclosure may apply to any or all of the embodiments of the apparel or footwear, outsole, and shoe (e.g., sports shoe) according to the present disclosure.

We emphasize that all aspects, features, and options discussed and disclosed above within the context of the some embodiments may be applied to, or combined with, the discussion and disclosure of other embodiments, and vice versa, unless physically or technically ruled out, even if not every possible combination or sub-combination of features is explicitly described herein. The technical advantages of such options and features that have already been discussed above are therefore not repeated, at least not to the same degree of detail, and reference is instead made to the corresponding explanations above, for conciseness.

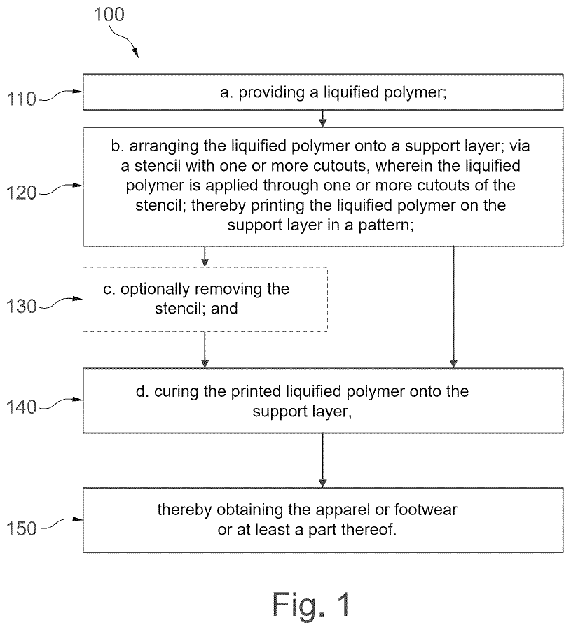

In FIG. 1, a flowchart for method 100 for manufacturing an apparel or footwear 240, such as a shoe 260 (e.g., a sports shoe), according to some embodiments of the present disclosure is shown.

In step 110, the liquified polymer may be provided. In some embodiments, the liquified polymer may comprise a polymer and a solvent. In some embodiments, the ratio of the polymer to the solvent ranges from 2:98 vol. % to 40:60 vol. %, from 5:95 vol. % to 30:70 vol. %, or from 10:90 vol. % to 20:80 vol. %.

In some embodiments, the liquified polymer 230 may be arranged in a first section of the apparel or footwear with a dynamic viscosity ranging from 50000 mPa·s to 200000 mPa·s. In some embodiments, in a second section of the apparel or footwear, the liquified polymer 230 may be arranged with a dynamic viscosity ranging from 10000 mPa·s to 50000 mPa·s.

In some embodiments, the liquified polymer 230 may comprise a dynamic viscosity ranging from 10000 mPa·s to 50000 mPa·s. In some embodiments, the liquified polymer 230 may comprise a dynamic viscosity ranging from 20000 mPa·s to 40000 mPa·s. In some embodiments, the liquified polymer may comprise a dynamic viscosity ranging from 100000 mPa·s to 500000 mPa·s, or from 100000 mPa·s to 300000 mPa·s.

In some embodiments, the contact angle θ between the liquified polymer 230 and the support layer 250 may range from 30° to 110°. In some embodiments, the contact angle θ between the liquified polymer 230 and the support layer may range from 40° to 90°. In some embodiments, the contact angle θ between the liquified polymer 230 and the support layer may range from 50° to 70°.

In some embodiments, the liquified polymer may comprise a polymer and a solvent; wherein the polymer is selected from the group consisting of polyurethanes (PU), thermoplastic polyamides (TPE-A or TPA), thermoplastic polyesters (TPE-E or TPE), thermoplastic styrenic block copolymers (TPE-S or TPS), thermoplastic polyurethanes (TPE-U or TPU), thermoplastic vulcanizates (TPE-V or TPV), rubber or ethylene-vinyl copolymer (EVA), and/or combinations thereof.

In some embodiments, the solvent may be a mixture selected from the group of solvent-borne and/or water-borne solvents. In some embodiments, the solvent may be a mixture selected from the group consisting of (C₁-C₆) ethers, (C₁-C₁₀) esters, (C₁-C₈) ketones, (C₁-C₈) alkanes, and/or combinations thereof.

In some embodiments, the solvent may be a mixture of one or more of tetrahydrofuran (THF), methyl ethyl ketone (MEK), cyclohexane (CYC), ethyl acetate, butyl acetate, acetone, acetonitrile, benzyl alcohol, chlorobenzene, dichloromethane, dimethyl sulfoxide (DMSO), methyl tert-butyl ether (MTBE), N-methyl-2-pyrrolidone (NMP), dimethylacetamide (DMAC), dimethylformamide (DMF), pyridine, and/or toluene. In some embodiments, the solvent may be cyclohexanone.

In some embodiments, the ratio of the mixture may range from 10 vol. % to 90 vol. %., from 20 vol % to 80 vol. %, from 30 vol. % to 70 vol. %. In some embodiments, the concentration of the polymer may range from 5 wt. % to 60 wt. %, from 7 wt. % to 50 wt. %, from 10 wt. % to 40 wt. %, or from 15 wt. % to 30 wt. %.

In some embodiments, the polymer may be characterized by a Shore A value and/or Shore D value, wherein the Shore A value ranges from 20 to 120, from 40 to 100, or from 60 to 80; and the Shore D value ranges from 2 to 80, from 5 to 75, or from 8 to 70.

Furthermore, and as can be taken from FIG. 1, in some embodiments, the liquified polymer may be arranged in step 120 onto a support layer. The support layer may be a film and/or a midsole, thus, may also be a layer, which is not part of the shoe (e.g., sports shoe). In other words, in some embodiments, the support layer may be any layer for arranging the liquified polymer.

In step 120, in some embodiments, the liquified polymer may be arranged onto a support layer via a stencil with one or more cutouts, wherein the liquified polymer may be applied through one or more cutouts of the stencil. In this manner, in some embodiments, the liquified polymer may be printed on the support layer in a pattern.

In some embodiments, the stencil may be made from alumina and/or steel. In some embodiments, any material which is unreactive and/or non-dissolvable towards the solvent used in the production of the liquified polymer and/or the support layer may be used.

In some embodiments, the arrangement of the liquified polymer 230 in step 120 may be performed by dispensing, spraying, jetting, printing, coating, spin coating, casting, depositing, dipping, brushing, roller coating, injecting and/or additive manufacturing, such as stereolithography (SLA) and/or selective laser sintering (SLS).

In some embodiments, the liquified polymer 230 may be arranged onto the support layer with a thickness ranging from 1 mm to 10 mm. In some embodiments, the liquified polymer may be arranged onto the support layer with a thickness ranging from 0.17 mm to 1 mm. In some embodiments, the support layer 250 may be a mid-sole and/or a shoe upper and/or parts thereof. In some embodiments, the liquified polymer may be arranged onto the support layer with a thickness ranging from 0.17 mm to 1 mm.

In some embodiments, the liquified polymer 230 may be arranged in a first section of the sports shoe 260 with a dynamic viscosity ranging from 30000 mPa·s to 50000 mPa·s and in a second section of the sports shoe 260 with a dynamic viscosity ranging from 10000 mPa·s to 30000 mPa·s. In some embodiments, the contact angle θ between the liquified polymer 230 and the support layer 250 may range from 30° to 110°, from 40° to 90°, or from 50° to 70°.

In step 120, in some embodiments, the liquified polymer may be arranged by brushing, coating, dipping, painting, automated dispensing, automated printing, and/or controlled dispensing.

In some embodiments, the liquified polymer may be arranged onto one or more regions of the shoe 260 (e.g., the sports shoe). In some embodiments, these regions may be a toe region, a forefoot region, a heel region, a midsole region, a sidewall region, and/or an upper region. In some embodiments, the liquified polymer 230 may be additionally or alternatively arranged onto one or more predetermined regions of the shoe 260 (e.g., the sports shoe) determined using a torsion map, an abrasion map, and/or a pressure map. In this manner, in some embodiments, the liquified polymer can be arranged based on individual needs and requirements of the wearer.

In step 120, in some embodiments, the liquified polymer 230 may be arranged onto the support layer with a thickness ranging from 0.1 mm to 10 mm. In some embodiments, the liquified polymer 230 may be arranged onto the support layer with a thickness ranging from 0.12 mm to 4 mm. In some embodiments, the liquified polymer 230 may be arranged onto the support layer with a thickness ranging from 0.15 mm to 2 mm. In some embodiments, the liquified polymer 230 may be arranged onto the support layer with a thickness ranging from 0.17 mm to 1 mm. In some embodiments, the liquified polymer 230 may be arranged onto the support layer with a thickness ranging from 0.2 mm to 0.8 mm.

In some embodiments, the thickness of the apparel or footwear 240 or at least a part thereof may range from 0.3 mm to 0.7 mm. In some embodiments, the thickness of the apparel or footwear may be 0.5 mm. In the context of a shoe (e.g., a sports shoe), this thickness may not include the midsole. In some embodiments, however, the thickness may comprise the midsole.

In step 120, in some embodiments, the liquified polymer may be applied through one or more cutouts of the stencil. In this manner, in some embodiments, the liquified polymer may be printed on the support layer in a pattern. The pattern may be a grid, a lattice, a line, a spiral, a honeycomb, dots, a wave, a sine wave pattern, or any combinations thereof.

In some embodiments, the stencil is a screen. In some embodiments, the stencil is a mesh. In some embodiments, the mesh may comprise at least 12 yarns per square cm², at least 24 yarns per square cm², and/or 32 yarns per square cm². In some embodiments, the mesh further comprises a yarn diameter of at least 50 μm, at least 80 μm, or at least 100 μm.

In some embodiments, force may be applied to the stencil when the liquified polymer is applied. In this manner, in some embodiments, the force may promote the liquified polymer being sufficiently printed and a pattern obtained.

In some embodiments, in the step 130 shown in dashed lines in FIG. 1, the stencil may be removed after printing the liquified polymer in a pattern. In some embodiments, the stencil comprising the liquified polymer throughout its one or more cutout(s) may not be removed but may remain on the support layer 250.

In step 140, in some embodiments, the printed liquified polymer may be cured onto the support layer 250. In this manner, in some embodiments, the apparel or footwear 240 may be obtained, or at least a part thereof. In some embodiments, curing may be carried out using radiation. In some embodiments, the stencil may remain on the support layer 250 during the step of curing the polymer.

In some embodiments, the solvent may be a water-soluble solvent selected from the group consisting of: ethanol, acetone, isopropyl alcohol, methanol, glycerol, propylene glycol, and/or dimethyl sulfoxide (DMSO). In some embodiments, the step of curing the printed liquified polymer may comprise the step of treating the printed liquified polymer with an extraction agent, such as water.

In some embodiments, the cured printed polymer may be removed in step 160 from the support layer 250, thereby obtaining at least a part of the apparel or footwear 240. Additionally or alternatively, in some embodiments, the part of the apparel or footwear 240 may be attached in step 165 to a base layer. In this regard, in some embodiments, the base layer may be a mid-sole.

In some embodiments, the support layer with the cured printed polymer may be attached to a base layer, such as a bottom part of a midsole. In some embodiments, the support layer 250 may be removed from the part of the apparel or footwear 240. In this manner, in some embodiments, at least a part of the apparel or footwear 240 attached on the base layer may be obtained.

In some embodiments, the step of attaching 165 may be performed at a temperature ranging from 30° C. to 300° C.. In some embodiments, the step of attaching 165 is performed at a temperature ranging from 50° C. to 280° C.. In some embodiments, the step of attaching 165 is performed at a temperature ranging from 70° C. to 260° C. Additionally or alternatively, in some embodiment, the step of attaching is performed in at most 12 minutes. In some embodiments, the step of attaching 165 is performed in at most 10 minutes. In some embodiments, the step of attaching 165 is performed in at most 6 minutes. In some embodiments, the step of attaching 165 is performed in at most 4 minutes. In some embodiments, the step of attaching is performed in at most 2 minutes. In some embodiments, the step of attaching is performed in at most 1 minute.

In some embodiments, the step of attaching 165 the part of the apparel or footwear 240 to the base layer comprises one or more of glueing, cementing, press-heating, pressing and/or injection molding.

In some embodiments, when using DMSO to redissolve the part and/or the midsole, the part and/or the midsole may be brought into contact with the solvent, such as DMSO. In some embodiments, the stencil-printed pattern arranged on the support layer, such as a film, e.g., a transfer film, may be placed on the midsole which in turn may be placed on, e.g., a support structure to prevent deformation when under load.

In some embodiments, a component comprising the negative of the pattern of the midsole and/or outsole structure may be placed on top of the support layer 250. In the subsequent step, in some embodiments, this arrangement may be transferred and left for drying. During drying, the part and/or midsole and/or film may be loaded with weight(s) ranging from 100 g to 100 kg. In this manner, in some embodiments, the weight(s) may promote bonding.

In some embodiments, when heat-pressing the part according to the present disclosure, no drying may be performed. For example, in some embodiments, bonding will be established via application of heat. E.g., heat may be applied during bonding. In some embodiments, the part and/or mid-sole and/or film may be loaded with weight(s) ranging from 100 g to 100 kg. In this manner, in some embodiments, the weight(s) may promote bonding. In some embodiments, the value of the weight(s) may vary. In some embodiments, no weight may be applied.

Any of the embodiments described herein may be combined where compatible. For example, in some embodiments, the first bonding may be achieved via DMSO and subsequently a heat-pressing step may be conducted to promote better bonding, e.g., on the rim of the structure.

In some embodiments, the step of attaching 165 the part of the apparel or footwear 240 may comprise melting 170 the part 240. Subsequently, in some embodiments, the melted part 240 may be sintered 175 and the sintered part may be redissolved 180. Subsequently, in some embodiments, the redissolved part may be welded 185. Finally, in some embodiments, the welded part may be pressed 190 to the base layer.

In some embodiments, welding the part may be performed using infrared radiation (IR), high frequency (HF) radiation, and/or ultrasonic radiation. In this regard, in some embodiments, the part 240 of the footwear may be an outsole 290 of the sports shoe 260. In some embodiments, the support layer 250 is a midsole. In some embodiments, the support layer 250 may be a shoe upper. In some embodiments, the support layer may be parts thereof (e.g., parts of a midsole or upper).

In some embodiments, the support layer 250 may be a film. In some embodiments, any film material, which is not soluble with the extraction agent or solvent used in the production of the liquified polymer may be used. For example, in some embodiments, when using water as an extraction agent, the film material may not be water-soluble, e.g., textile, fiber, polyester-based materials, nylon or the like.

In some embodiments, the midsole may comprise a polymer based on expanded thermoplastic polyurethane. In some embodiments, the midsole may comprise a polymer selected from the group consisting of: thermoplastic polyurethanes (TPUs), polyether block amide (PEBA), ethylene vinyl acetate (EVA), thermoplastic elastomers, and/or polyurethane and/or expanded thermoplastic polyurethane (eTPU).

In some embodiments, the liquified polymer and the midsole may be dissolvable by the solvent. In such configurations (as well as others), a base material of the liquified polymer and a base material of solvent may be the same. In some embodiments, the polymer of the support layer, when being a midsole, and the liquified polymer are based on the same polymer, such as TPU.

In the curing step 140, in some embodiments, a curing temperature ranging from 20° C. to 250° C. may be used. In some embodiments, a curing temperature ranging from 30° C. to 150° C. may be used. In some embodiments, a curing temperature ranging from 40° C. to 50° C. may be used. In the curing step 140 of the liquified polymer 230, in some embodiments, the curing time may range from 2 minutes to 750 minutes. In some embodiments, the curing time may range from 5 minutes to 390 minutes. In some embodiments, the curing time may range from 10 minutes to 180 minutes.

In some embodiments, in the curing step 140, a curing temperature ranging from 20° C. to 150° C. may be used. In some embodiments, a curing temperature ranging from 40° C. to 100° C. may be used. In some embodiments, a curing temperature ranging from 60° C. to 80° C. may be used. In some embodiments, a curing temperature ranging from 72°C. to 78° C. may be used. In the step 140 of curing the liquified polymer 230, in some embodiments, the curing time may range from 2 minutes to 24 hours. In some embodiments, the curing time may range from 5 minutes to 12 hours. In some embodiments, the curing time may range from 10 minutes to 6 hours. In some embodiments, the curing time may range from 20 minutes to 3 hours.

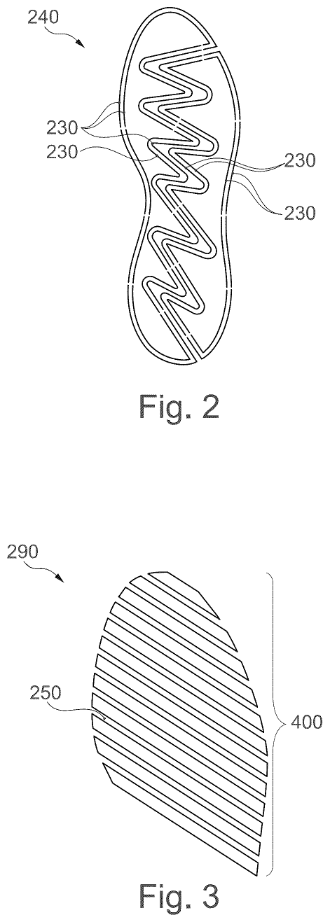

In order to avoid unnecessary redundancy, differences and/or additions to the embodiments of the method described with respect to FIG. 1 will be discussed with respect to the embodiments shown in FIGS. 2 to 4.

In FIG. 2, an embodiment of apparel or footwear 240 or at least a part thereof, which may be manufactured according to some embodiments of the method 100 according to the present disclosure, discussed in the context of FIG. 1 above, is shown. As can be taken from FIG. 2, in some embodiments, the apparel or footwear 240 may have a matte design. In some embodiments, the stencil which has been used for printing the liquified polymer may be made from alumina and/or steel material. As shown in FIG. 2, the stencil has not (yet) been removed from the support layer. In some embodiments, the printed polymer may be cured on the support layer without removing the stencil. In some embodiments, it may also be desirable to remove the stencil in a subsequent step.

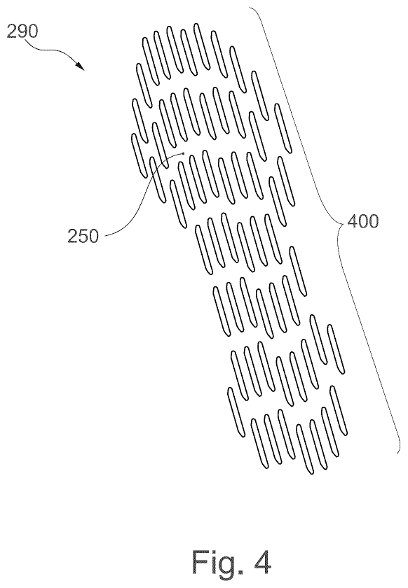

In FIGS. 3 and 4, embodiments of an outsole 290 manufactured according to some embodiments of the method 100 according to the present disclosure is shown. As can be taken from FIG. 3, in some embodiments, the outsole 290 may have a pattern and a surface structure 400, which has been formed by the arrangement of the cured polymer. For example, in some embodiments, the surface structure 400, as shown in FIG. 3, may be a linear and continuous pattern with an oblique parallel alignment. In some embodiments, the cured polymer may be arranged in one or more stripe(s) with a substantially constant distance between the one or more stripe(s). In some embodiments, one or more stripes may not comprise a substantially constant distance, as can be taken from FIG. 3. In some embodiments, the one or more stripes may comprise a constant distance. For doing so, a stencil with cutouts comprising constant distances may be used, in some embodiments. In some embodiments, the support layer 250 may be visible in between the arrangement of the cured polymer in FIG. 3. As can be taken from FIG. 3, in some embodiments, the support layer 250 may be a film layer.

In some embodiments, the outsole 290, as shown in FIG. 4, may have a linear and discontinuous pattern. In some embodiments, the surface structure 400 of the outsole 290 may be arranged vertically along the longitudinal axis of the outsole 290. In some embodiments, the outsole may have a pattern which may comprise one or more bar(s) made from the arranged cured polymer. The one or more bar(s) may be arranged in a continuous distance to each other. In some embodiments, the one or more bar(s) may be arranged in a plurality of rows. Like in FIG. 3, in FIG. 4, the support layer 250 may be a film layer.

It is noted that some embodiments and/or examples may be combined with other embodiments described herein and details of the embodiments and/or examples may also be omitted, as will be understood by a skilled artisan. The scope of the present disclosure is not limited by the embodiments and/or examples described herein.

1. A method for manufacturing an article of apparel, comprising:
providing a liquified polymer;
arranging the liquified polymer onto a support layer via a stencil with one or more cutouts, wherein the liquified polymer is applied through the one or more cutouts of the stencil, thereby printing the liquified polymer on the support layer in a pattern;
removing the stencil, and
curing the printed liquified polymer on the support layer.

2. The method according to claim 1, wherein the liquified polymer comprises a polymer and a solvent.

3. The method according to claim 2, wherein the solvent is a water-soluble solvent selected from the group consisting of: ethanol, acetone, isopropyl alcohol, methanol, glycerol, propylene glycol, and dimethyl sulfoxide.

4. The method according to claim 3, wherein curing the printed liquified polymer comprises treating the printed liquified polymer with an extraction agent.

5. The method according to claim 1, further comprising:
removing the cured printed polymer from the support layer; and
attaching at least a portion of the cured printed polymer to a base layer.

6. The method according to claim 1, further comprising:
attaching the support layer with the cured printed polymer to a base layer, wherein the base layer is a bottom portion of a midsole; and
removing the support layer from the cured printed polymer, thereby disposing at least a portion of the cured printed polymer on the base layer.

7. The method according to claim 5, wherein attaching is performed at a temperature ranging from 30° C. to 300° C., and/or the attaching is performed in at most 12 minutes.

8. The method according to claim 7, wherein attaching the at least a portion of the cured printed polymer to the base layer comprises one or more of glueing, cementing, press-heating, pressing, and injection molding.

9. The method according to claim 5, wherein attaching the at least a portion of the cured printed polymer comprises:
melting the at least a portion of the cured printed polymer;
sintering the melted portion of the printed polymer;
redissolving the sintered portion of the printed polymer;
welding the redissolved portion of the printed polymer; and
pressing the welded portion of the printed polymer to the base layer.

10. The method according to claim 9, wherein welding the redissolved portion of the printed polymer is performed using infrared radiation (IR), high frequency (HF) radiation, and/or ultrasonic radiation.

11. The method according to claim 1, wherein arranging the liquified polymer onto the support layer comprises one or more of: dispensing, spraying, jetting, printing, coating, spin coating, casting, depositing, dipping, brushing, roller coating, injecting, and additive manufacturing of the liquified polymer.

12. The method according to claim 1, wherein curing the printed liquified polymer on the support layer forms at least a portion of an outsole of a shoe.

13. The method according to claim 1, wherein the support layer is at least a portion of a midsole or at least a portion of an upper of a shoe.

14. The method according to claim 1, wherein the support layer is a film.

15. The method according to claim 13, wherein the midsole comprises a polymer selected from the group consisting of: thermoplastic polyurethanes (TPUs), polyether block amide (PEBA), ethylene vinyl acetate (EVA), and thermoplastic elastomers.

16. The method according to claim 1, wherein the liquified polymer is arranged onto one or more of a toe region, a forefoot region, a heel region, a midsole region, a sidewall region, and an upper region of a shoe.

17. The method according to claim 1, wherein the liquified polymer is arranged onto one or more predetermined regions of an article of apparel determined using a torsion map, an abrasion map, and/or a pressure map.

18. The method according to claim 1, wherein the liquified polymer is arranged onto the support layer with a thickness ranging from 0.1 mm to 10 mm.

19. The method according to claim 1, wherein the thickness of the cured printed polymer and the support layer, together, ranges from 0.3 mm to 0.7 mm.

20. The method according to claim 1, wherein the stencil is a screen.
